(19) United States
(12) Patent Application Publication
(10) Pub. No.: US 2022/0376561 A1
(43) Pub. Date: Nov. 24, 2022

(54) RECEIVER FOR WIRELESSLY RECEIVING ENERGY AND A METHOD THEREOF

(71) Applicant: MSC ENGINEERING SERVICES, LLC, Princeton, NJ (US)

(72) Inventors: Sanjay GUPTA, Bedford, MA (US); Ming LIU, Shanghai (CN); Chengbin MA, Shanghai (CN)

(21) Appl. No.: 17/559,240

(22) Filed: Dec. 22, 2021

Related U.S. Application Data
(60) Provisional application No. 63/190,966, filed on May 20, 2021.

(51) Int. Cl. H02J 50/70; H02J 50/40; H02J 50/12

(52) U.S. Cl. CPC H02J 50/70; H02J 50/402; H02J 50/12

(57) ABSTRACT

A receiver is for wirelessly receiving energy to power a device. The receiver comprises a plurality of receiver coils spaced apart from each other and a receiver circuitry connected to each of the plurality of receiver coils. Each of the plurality of receiver coils is configured to operate in a same wireless power frequency range and receive the energy from a transmitter. The receiver circuitry is configured to combine the energy received by each of the plurality of receiver coils to power the device.

### BACKGROUND OF THE INVENTION

In recent years, wireless power transfer systems have gained popularity as a convenient way to transfer power wirelessly from a transmitter of a wireless charger to a wireless receiver of a device. Generally, these wireless power transfer systems use the mutual inductance between a coil in the transmitter and a coil in the receiver to transfer power through magnetic induction. Several industry committees are working on developing wireless charging standards for such transmitters and receivers utilizing the wireless power transfer with power frequencies ranging from hundreds of kilohertz (“kHz”) to a few megahertz (“MHz”). Since the specific applications for different power frequency ranges are different, the wireless transmitters are designed to accommodate multiple power frequency ranges corresponding to different wireless charging standards. To do so, such wireless transmitters include multiple coils and circuitries each corresponding to one of multiple power frequency ranges, wherein each coil and circuitry couples with the corresponding coil and circuitry of the receiver operating in the same power frequency range.

However, oftentimes having multiple coils in the wireless transmitter may result in unwanted coupling between coils corresponding to different power frequency ranges. For example, when a transmitter including a first coil operating in a first power frequency range and a second coil operating in a second power frequency range is utilized to charge a receiver having a coil operating in the first power frequency range, an undesired cross-coupling may also occur between the second coil of the transmitter and the coil of the receiver. This undesired cross coupling causes additional power losses and impacts the efficiency of the wireless power systems. Further, it may also impact the operation of the circuitry associated with the second coil of the transmitter.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 illustrates a wireless power transmission system including a wireless power receiver, in accordance with various embodiments.

FIGS. 2A through 2C illustrate an exemplary working of the wireless power receiver in the wireless power transmission system, in accordance with various embodiments.

FIG. 3A illustrates a circuit diagram of the wireless power transmission system, in accordance with various embodiments.

FIG. 3B illustrates a circuit diagram of the wireless power transmission system, in accordance with various other embodiments.

FIG. 4A illustrates a block diagram of the wireless power receiver, in accordance with various embodiments.

FIG. 4B illustrates a block diagram of the wireless power receiver, in accordance with various other embodiments.

FIG. 5 illustrates an exemplary method for wirelessly receiving energy by the wireless power receiver, in accordance with some embodiments.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

In one aspect, a receiver for wirelessly receiving energy to power a device is described. The receiver comprises a plurality of receiver coils spaced apart from each other and a receiver circuitry connected to each of the plurality of receiver coils. Each of the plurality of receiver coils is configured to operate in a same wireless power frequency range and receive the energy from a transmitter. The receiver circuitry is configured to combine the energy received by each of the plurality of receiver coils to power the device.

In another aspect, a method for wirelessly receiving energy by a receiver to power a device is described. The method comprises receiving, by a plurality of receiver coils, the energy from a transmitter. The method further comprises combining, by a receiver circuitry in the receiver, the energy received by each of the plurality of receiver coils to power the device. The plurality of receiver coils are spaced apart from each other and operate in a same wireless power frequency range.

In yet another aspect, a device comprising a receiver configured to wirelessly receive energy for operation of the device is described. The receiver comprises a plurality of receiver coils spaced apart from each other and a receiver circuitry connected to each of the plurality of receiver coils. Each of the plurality of receiver coils is configured to operate in a same wireless power frequency range and receive the energy from a transmitter. The receiver circuitry is configured to combine the energy received by each of the plurality of receiver coils to power the device.

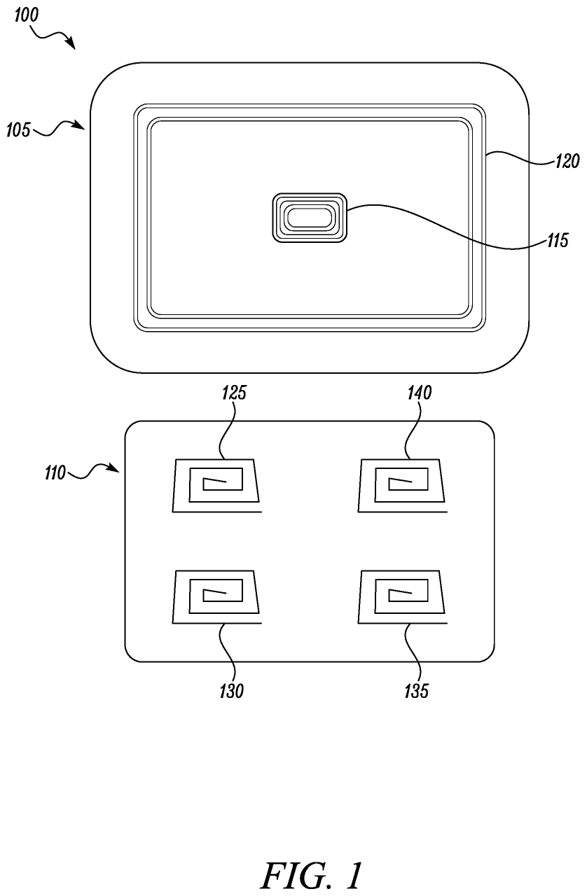

FIG. 1 illustrates a wireless power transmission system 100. As shown, the wireless power transmission system 100 includes a wireless power transmitter 105 (hereinafter interchangeably referred to as a transmitter 105) and a wireless power receiver 110 (hereinafter interchangeably referred to as a receiver 110). The wireless power transmitter 105 is configured to transmit energy wirelessly to the wireless power receiver 110 and the wireless power receiver 110 is configured to wirelessly receive the energy transmitted from the wireless power transmitter 105.

The wireless power transmitter 105 shown in FIG. 1 is any conventional wireless power transmitter configured to transmit energy to multiple wireless power receivers operating in different wireless power frequency ranges. The wireless power transmitter 105 is employed in any wireless charger, wireless charging pad, or a wireless power supply unit to transfer energy wirelessly. Although the forthcoming disclosure describes a specific configuration of the wireless power transmitter 105, a person skilled in the art would appreciate that the wireless power transmitter 105 as shown in FIG. 1 may include configuration of any wireless power transmitter, already known or future developed, to transmit energy to multiple wireless power receivers operating in different wireless power frequency ranges.

The wireless power transmitter 105 is configured to transmit energy to multiple wireless power receivers operating in different wireless power frequency ranges corresponding to different wireless charging standards. It will be appreciated by those of ordinary skill in the art that the wireless charging standards may include, for example, the Wireless Power Consortium's Qi standard, the Power Matter Alliance's PMA standard, the AirFuel standard, or any other wireless charging standard now known or future developed. To this end, the wireless power transmitter 105 includes multiple wireless power transmission coils, such as but not limited to, a first transmitter coil 115 and a second transmitter coil 120, operating in different power frequency ranges corresponding to the different wireless charging standards. For example, the first transmitter coil 115 may be configured to operate in a first wireless power frequency range of a few kHz, such as, between 100 to 300 kHz corresponding to a first wireless charging standard, such as, Qi standard. Similarly, the second transmitter coil 120 may be configured to operate in a second wireless power frequency range of MHz, such as, at 6.78 MHz corresponding to a second wireless charging standard, such as the AirFuel standard.

The first transmitter coil 115 operating in the first wireless power frequency range is configured to transmit energy to a corresponding receiving coil of a wireless power receiver operating in the same first wireless power frequency range corresponding to the first wireless charging standard. Similarly, the second transmitter coil 120 operating in the second wireless power frequency range is configured to transmit energy to a corresponding receiving coil of a wireless power receiver operating in the same second wireless power frequency range corresponding to the second wireless charging standard. The first transmitter coil 115 and the second transmitter coil 120 is configured to employ one of the various wireless power transmission schemes including, for example, an electromagnetic induction scheme, an electromagnetic resonance scheme, a radio frequency (“RF”) power transmission scheme, and the like to transmit energy to the corresponding receiver coil.

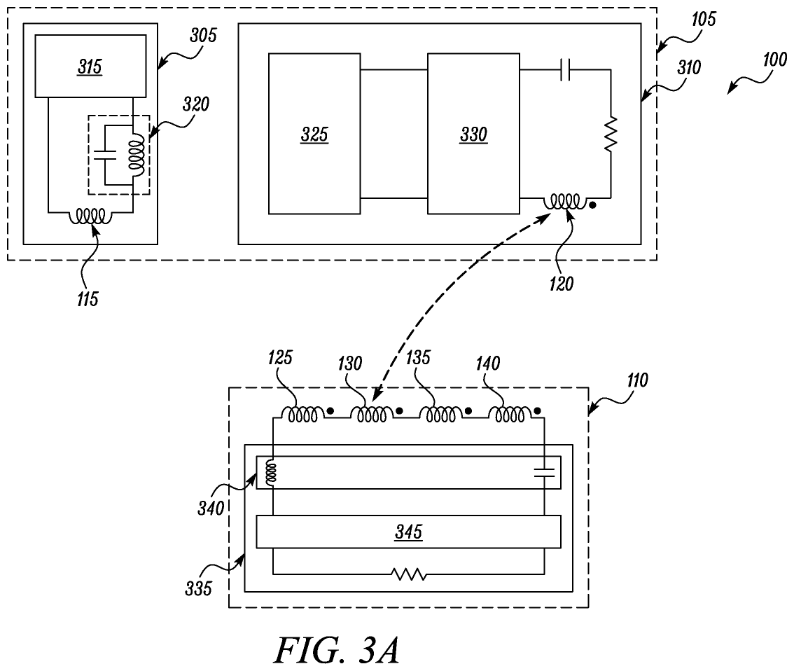

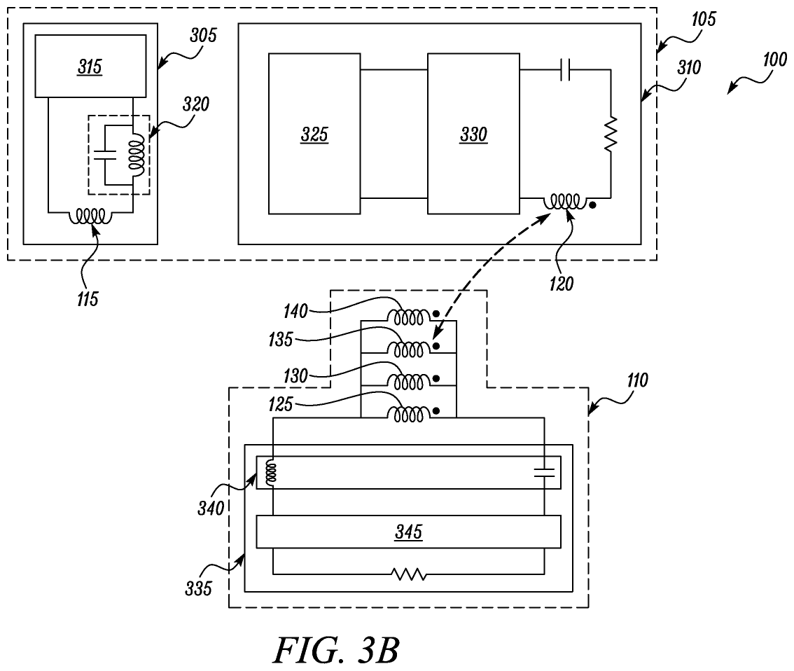

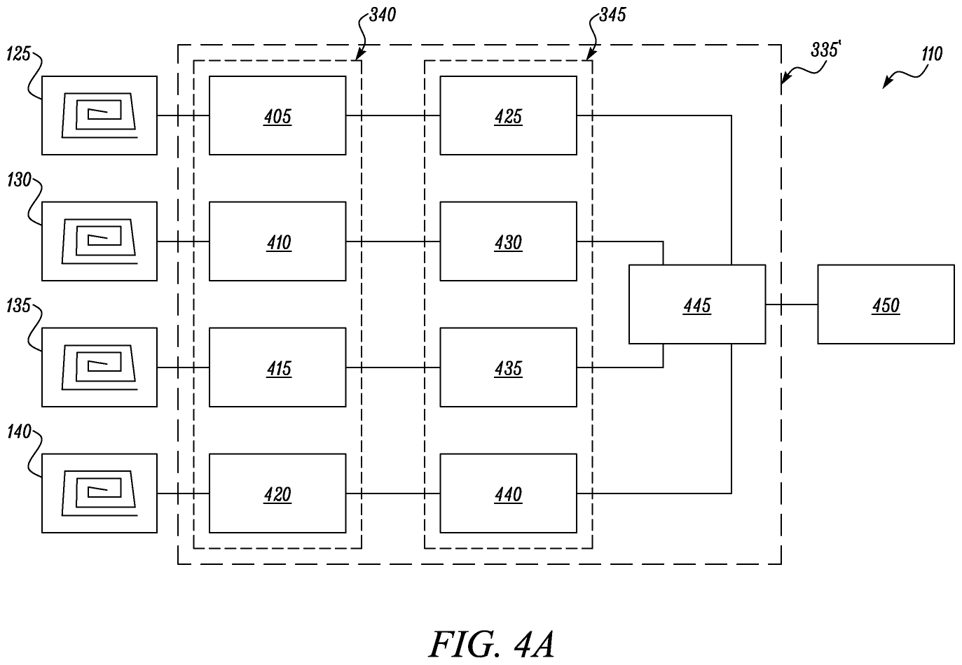

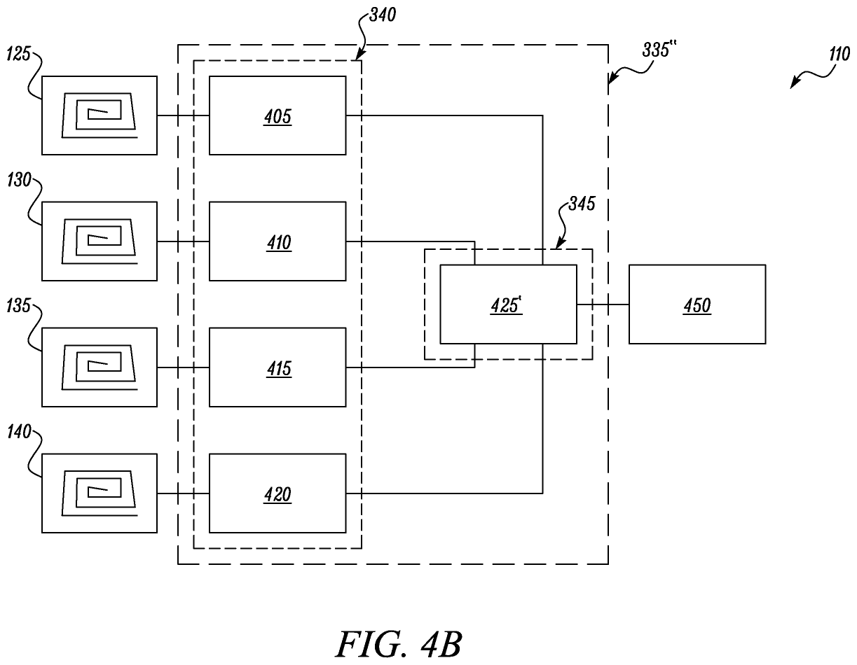

In wireless power transmission systems using conventional wireless power receivers (not shown) with a single receiver coil operating either in the first wireless power frequency range or the second wireless power frequency range, an undesired cross coupling occurs between the coils during the energy transfer. For example, when the second transmitter coil 120 operating in the second wireless power frequency range is moved to be in the vicinity of the receiver coil operating in the same second wireless power frequency range for the energy transmission, a certain amount of the energy received by the receiver coil is transmitted back to the first transmitter coil 115 of the wireless power transmitter 105 due to co-location of the receiver coil and the first transmitter coil 115 in the same electromagnetic domain. In other words, when the energy is transmitted from the second transmitter coil 120 of the wireless power transmitter 105 to the corresponding receiver coil, the receiver coil in-turn induces high frequency power on the first transmitter coil 115 of the wireless power transmitter 105. This results in an undesired cross coupling between the receiver coil and the first transmitter coil 115 of the wireless power transmitter 105. In some cases, this also results in an undesired additional power consumption by the parasitic resistances of the first transmitter coil 115 and its corresponding circuitry (shown hereinafter in FIGS. 3A, 3B, 4A, 4B) causing high power loss and severe heating problems. Similarly, when the first transmitter coil 115 operating in the first wireless power frequency range is moved to be in the vicinity of a corresponding receiver coil operating in the same first wireless power frequency range for the energy transmission, an undesired cross-coupling occurs between the second transmitter coil 120 and the receiver coil resulting in the same type of problems as described above.

The present disclosure is directed towards minimizing the undesired cross-coupling, power loss, and heating during the wireless power transmissions. To this end, in various embodiments, a wireless power receiver 110 is configured to receive energy from the wireless power transmitter 105 while minimizing the undesired cross-coupling, power loss, and heating. In accordance with various embodiments, the wireless power receiver 110 is configured to be employed in any device for receiving energy wirelessly for the operation of the device. For example, the wireless power receiver 110 may be employed in any high-power device, such as but not limited to, a laptop, a tablet, and the like or a low-power device, such as but not limited to, a mobile telephone, an electric toothbrush, and the like. In an embodiment, the wireless power receiver 110 is configured to supply the received energy to a load of the device to directly power the device. In some other embodiments, the wireless power receiver 110 is configured to supply the received energy to a battery of the device to charge the battery.

The wireless power receiver 110 includes a plurality of wireless power receiver coils, such as but not limited to, a first receiver coil 125, a second receiver coil 130, a third receiver coil 135, and a fourth receiver coil 140 spaced apart from each other. In an exemplary embodiment as shown in FIG. 1, the plurality of receiver coils 125, 130, 135, 140 are placed at or close to the four different corners on the periphery of the wireless power receiver 110. In one embodiment, the plurality of receiver coils 125, 130, 135, 140 are placed at or close to the four different corners such that the arrangement of the receiver coils 125, 130, 135, 140 define a central space devoid of any coil. Although not shown, a person skilled in the art would appreciate that the plurality of receiver coils 125, 130, 135, 140 may be arranged in various configurations on the wireless power receiver 110 in a manner that the plurality of receiver coils 125, 130, 135, 140 are spaced apart from each other. As shown, each of the plurality of receiver coils 125, 130, 135, 140 is arranged on the wireless power receiver 110 in a rectangular shape. Although not shown, each of the plurality of receiver coils 125, 130, 135, 140 may be implemented in various other forms such as, but not limited to, a planar spiral shape or a cylindrical solenoid shape.

In accordance with various embodiments, the wireless power receiver 110 is a single frequency multi-coil wireless power receiver that is configured to operate in a single wireless power frequency range. To this end, each of the plurality of receiver coils 125, 130, 135, 140 are configured to operate in a same wireless power frequency range. In accordance with some embodiments, the wireless power frequency range is one of the first wireless power frequency range or the second wireless power frequency range. Particularly, when the wireless power receiver 110 is configured to receive energy in the first wireless power frequency range, the plurality of receiver coils 125, 130, 135, 140 are configured to operate in the first wireless power frequency range. In such cases, each of the plurality of receiver coils 125, 130, 135, 140 are configured to receive energy from the first transmitter coil 115 of the wireless power transmitter 105. Similarly, when the wireless power receiver 110 is configured to receive energy in the second wireless power frequency range, the plurality of receiver coils 125, 130, 135, 140 are configured to operate in the second wireless power frequency range. In such cases, the plurality of receiver coils 125, 130, 135, 140 are configured to receive energy from the second transmitter coil 120 of the wireless power transmitter 105. Although the present disclosure describes a single-mode wireless power receiver 110 configured to receive energy in a single wireless power frequency range, a person skilled in the art would appreciate that the wireless power receiver 110 may be employed in any wireless power receiver configured to operate on more than one wireless power frequency ranges, without departing from the scope of the present disclosure.

In accordance with various embodiments, each of the plurality of receiver coils 125, 130, 135, 140 in the wireless power receiver 110 is configured to be selectively activated to receive energy from the corresponding wireless transmitter coil 115, 120 of the wireless power transmitter 105. Particularly, each receiver coil 125, 130, 135, 140 is configured to be selectively activated when the respective receiver coil 125, 130, 135, 140 is in the vicinity of the corresponding wireless transmitter coil 115, 120. In other words, the receiver coils 125, 130, 135, 140 that are not in the vicinity of the corresponding wireless transmitter coil 115, 120 are not activated to receive energy.

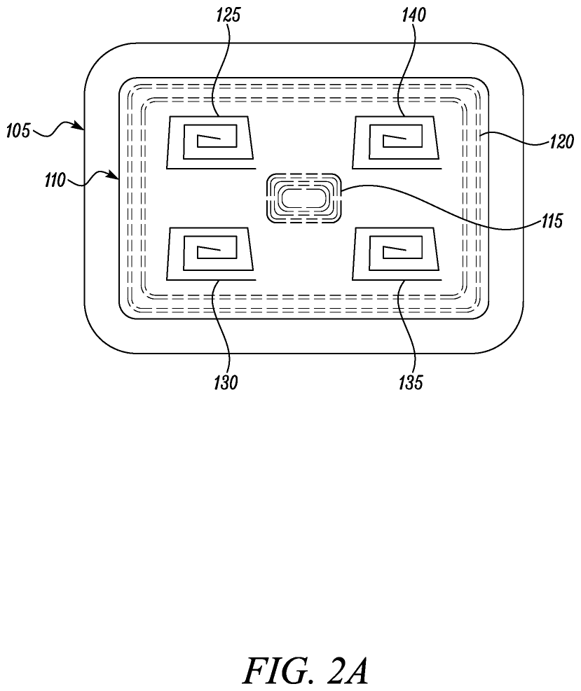

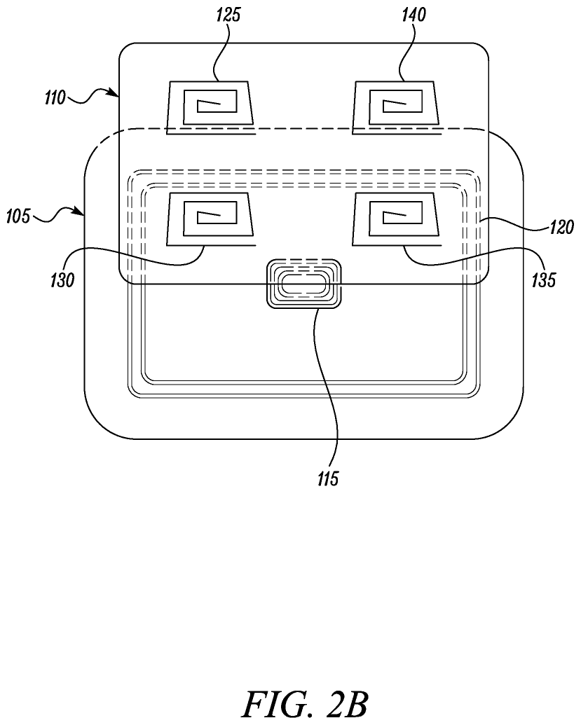

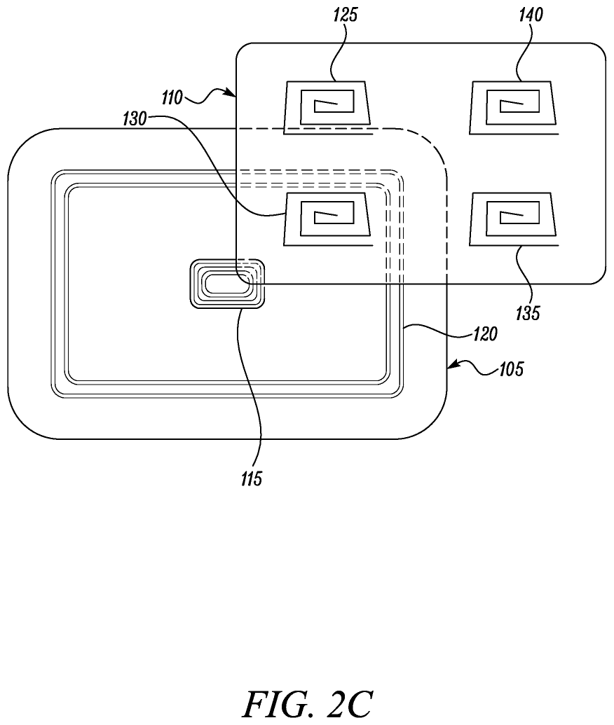

In some embodiments, two or more of the plurality of receiver coils 125, 130, 135, 140 are configured to be simultaneously activated to receive energy when each of the two or more of the plurality of receiver coils 125, 130, 135, 140 are in the vicinity of the respective wireless transmitter coil 115, 120. For example, FIG. 2A illustrates an exemplary scenario when each of the plurality of receiver coils 125, 130, 135, 140 is in the vicinity of the respective transmitter coil, for example, the second transmitter coil 120. In this exemplary scenario, each of the plurality of receiver coils 125, 130, 135, 140 is activated to receive energy from the second transmitter coil 120 as each of the plurality of wireless receiver coils 125, 130, 135, 140 is in the vicinity of the second transmitter coil 120. Similarly, FIG. 2B illustrates another exemplary scenario when only the second receiver coil 130 and the third receiver coil 135 are in the vicinity of the second transmitter coil 120. In this exemplary scenario, the second receiver coil 130 and the third receiver coil 135 are activated to receive energy from the second transmitter coil 120. Similarly, in yet another exemplary scenario shown in FIG. 2C, the second wireless receiver coil 130 is activated to receive energy from the second transmitter coil 120 as the second wireless receiver coil 130 is in the vicinity of the respective second transmitter coil 120.

In accordance with some embodiments, the plurality of wireless receiver coils 125, 130, 135, 140 are configured to receive different energy levels from the corresponding transmitter coil 115, 120 of the wireless power transmitter 105. The energy level received by each of the plurality of wireless receiver coils 125, 130, 135, 140 depends on the vicinity of the respective wireless receiver coil 125, 130, 135, 140 from the corresponding transmitter coil 115, 120. Particularly, the wireless receiver coils 125, 130, 135, 140 that are closer to the corresponding transmitter coil 115, 120 receive more energy than the wireless receiver coils 125, 130, 135, 140 that are comparatively further away in distance from the corresponding transmitter coil 115, 120.

In accordance with various embodiments, the wireless power receiver 110 is configured to combine the energy received by each of the plurality of receiver coils 125, 130, 135, 140. To this end, the wireless power receiver 110 includes a receiver circuitry 335, 335′, 335″ (shown in FIGS. 3A and 3B, 4A and 4B) connected to each of the plurality of receiver coils 125, 130, 135, 140 to combine the energy received by each of the plurality of receiver coils 125, 130, 135, 140. The functioning of the receiver circuitry 335, 335′, 335″ is described in detail in the forthcoming disclosure with respect to FIGS. 3A-3B and 4A-4B. In some embodiments, each of the plurality of receiver coils 125, 130, 135, 140 is configured to selectively receive energy from the corresponding transmitter coil 115, 120.

FIGS. 3A and 3B illustrate circuit diagrams of the wireless power transmission system 100. The wireless power transmitter 105 in the wireless power transmission system 100, as shown in FIGS. 3A and 3B, is a conventional wireless power transmitter including a first circuitry 305 for transmitting energy in the first wireless power frequency range and a second circuitry 310 transmitting energy in the second wireless power frequency range. Generally, the first circuitry 305 includes a frequency inverter 315, a transmitter resonant circuit 320, and the first transmitter coil 115. The frequency inverter 315 is configured to receive direct current (“DC”) input from a power supply unit (not shown) and invert the received DC input to an alternating current (“AC”) current in the first power frequency range. The AC current transformed by the frequency inverter 315 drives the transmitter resonant circuit 320 and the first transmitter coil 115 to form a magnetic field in the first power frequency range at the first transmitter coil 115.

Similarly, as shown in FIGS. 3A and 3B, the second circuitry 310 includes a power amplifier 325, a transmitter matching network 330, and the second transmitter coil 120. The power amplifier 325 is configured to receive Direct Current (DC) input from the power supply unit (not shown) and convert the received DC input to high-frequency Alternating Current (AC) waveform in the second power frequency range. The AC current converted by the power amplifier 325 drives the transmitter matching network 330 and the second transmitter coil 120 to form a magnetic field in the second wireless power frequency range at the second transmitter coil 120. A person skilled in the art would appreciate that the circuitry and the functioning of the conventional wireless power transmitter 105 discussed above is well known in the art and is not described in detail in the present disclosure for the sake of brevity.

The wireless power receiver 110, in accordance with various embodiments, includes the plurality of receiver coils 125, 130, 135, 140, and a receiver circuitry 335 connected to each of the plurality of receiver coils 125, 130, 135, 140. When the wireless power receiver 110 is in the vicinity of the wireless power transmitter 105, each of the plurality of receiver coils 125, 130, 135, 140 is configured to receive energy by picking up the magnetic field formed by the corresponding first transmitter coil 115 or the second transmitter coil 120. Each of the plurality of receiver coils 125, 130, 135, 140 is further configured to induce an alternating current (AC) corresponding to the wireless energy received by the respective receiver coil 125, 130, 135, 140. For example, as shown in FIGS. 3A and 3B, when the wireless power receiver 110 is configured to operate in the second wireless power frequency range, the plurality of receiver coils 125, 130, 135, 140 are configured to induce AC corresponding to the wireless energy received from the corresponding transmitter coil 120 operating in the same second wireless power frequency range.

In an embodiment, as shown in FIG. 3A, the plurality of receiver coils 125, 130, 135, 140 are connected in a series configuration. In another embodiment, as shown in FIG. 3B, the plurality of receiver coils 125, 130, 135, 140 are connected in a parallel configuration. In yet another embodiment (not shown), the plurality of receiver coils 125, 130, 135, 140 are dynamically connected in any combination, depending upon the requirements and to maximize the efficiency of the wireless power transmission system 100. In accordance with various embodiments, the receiver circuitry 335 is configured to combine the energy received by each of the plurality of receiver coils 125, 130, 135, 140.

As shown in FIGS. 3A and 3B, the receiver circuitry 335 includes a matching network 340 and at least one rectifier 345. The matching network 340 is connected between the plurality of receiver coils 125, 130, 135, 140 and the at least one rectifier 345. The matching network 340 is configured to improve loading conditions and reduce electromagnetic interference. To this end, the matching network 340 is configured to match an output impedance of the plurality of receiver coils 125, 130, 135, 140 to an input impedance of the at least one rectifier 345. The at least one rectifier 345 is configured to convert the alternating current received from the plurality of receiver coils 125, 130, 135, 140 into a direct current. The at least one rectifier 345 is further configured to provide the direct current for the operation of the device in which the wireless power receiver 110 is employed.

FIG. 4A is a block diagram illustrating connection of the plurality of receiver coils 125, 130, 135, 140 with the components of the receiver circuitry 335′, in accordance with an embodiment. As shown in FIG. 4A, the receiver circuitry 335′ includes the matching network 340 having a plurality of matching circuits, such as a first matching circuit 405, a second matching circuit 410, a third matching circuit 415, a fourth matching circuit 420. In accordance with the present embodiment, the plurality of matching circuits 405, 410, 415, 420 are correspondingly connected to the plurality of receiver coils 125, 130, 135, 140. The receiver circuitry 335′ further comprises a plurality of rectifiers, such as a first rectifier 425, a second rectifier 430, a third rectifier 435, and a fourth rectifier 440. The plurality of rectifiers 425, 430, 435, 440 are correspondingly connected to the plurality of matching circuits 405, 410, 415, 420. The receiver circuitry 335′ further comprises a control unit 445 connected to the plurality of rectifiers 425, 430, 435, 440.

As described above, each of the plurality of receiver coils 125, 130, 135, 140 is configured to induce an alternating current corresponding to the wireless energy received by the respective receiver coil 125, 130, 135, 140. The plurality of rectifiers 425, 430, 435, 440, correspondingly connected to the plurality of receiver coils 125, 130, 135, 140, are further configured convert the alternating current received from the corresponding receiver coil 125, 130, 135, 140 into a direct current. The direct current is then provided to the control unit 445 that is configured to receive and combine the direct current from each of the plurality of rectifiers 425, 430, 435, 440 to power the device 450. In accordance with the present embodiment, the plurality of matching circuits 405, 410, 415, 420, correspondingly connected between the plurality of receiver coils 125, 130, 135, 140 and the plurality of rectifiers 425, 430, 435, 440, are configured to match an output impedance of the corresponding receiver coil 125, 130, 135, 140 to an input impedance of the corresponding rectifier 425, 430, 435, 440.

FIG. 4B is a block diagram illustrating connection of the plurality of receiver coils 125, 130, 135, 140 with the components of the receiver circuitry 335″, in accordance with another embodiment. As shown in FIG. 4B, in the present embodiment, the plurality of matching circuits 405, 410, 415, 420 are connected to a single rectifier 425′. The rectifier 425′ is further connected to the device 450. In accordance with the present embodiment, the rectifier 425′, connected to each of the plurality of matching circuits 405, 410, 415, 420, is configured to receive and combine the alternating current from the plurality of matching circuits 405, 410, 415, 420 for generating a direct current to power the device 450.

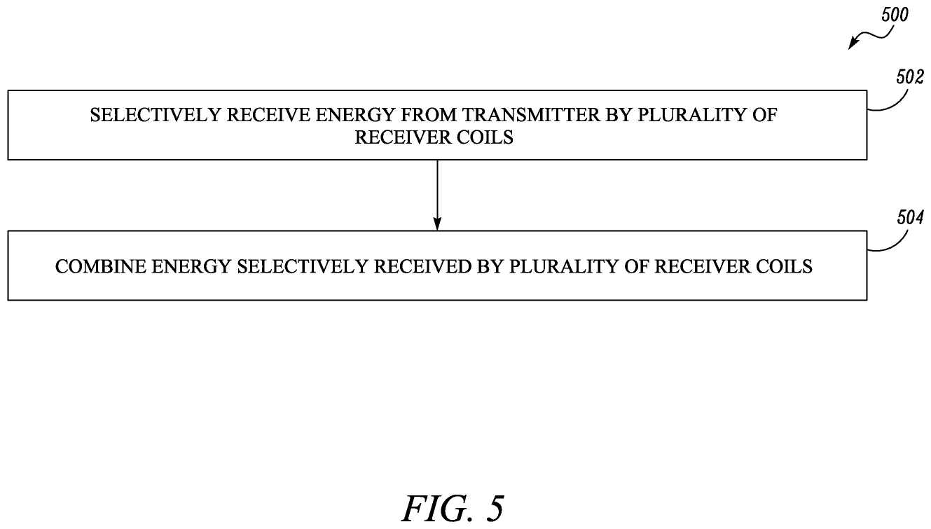

FIG. 5 illustrates an exemplary method 500 for wirelessly receiving energy by the wireless power receiver 110. The method begins, at 502, with the plurality of receiver coils 125, 130, 135, 140 receiving the energy from the wireless power transmitter 105. In accordance with various embodiments, receiving the energy by the plurality of receiver coils 125, 130, 135, 140 comprises activating, each of the plurality of receiver coils 125, 130, 135, 140, to receive the energy when the respective receiver coil 125, 130, 135, 140 is in the vicinity of the wireless power transmitter 105. In some embodiments, two or more of the plurality of receiver coils 125, 130, 135, 140 are activated simultaneously to receive the energy when the respective two or more of the plurality of receiver coils 125, 130, 135, 140 are in the vicinity of the wireless power transmitter 105. At 504, the receiver circuitry 335, 335′, 335″ combines the energy received by each of the plurality of receiver coils 125, 130, 135, 140 to power the device 450.

The present disclosure provides a novel architecture for building highly efficient wireless power transmission systems. By employing the multi-coil design in the wireless power receiver 110, the overlap between the receiver coils 125, 130, 135, 140 operating in the second wireless power frequency range of MHz and the transmitter coil 115 operating in a different wireless power frequency range, for e.g., the first wireless power frequency range of a few kHz can be reduced. This reduces the cross-coupling between both the receiver coils 125, 130, 135, 140 and the transmitter coil 115, and other problems, such as, power loss associated with the cross-coupling. Moreover, the multi-coil design in the wireless power receiver 110 allows for a better distribution of the generated heat between four different receiver coils 125, 130, 135, 140, thus improving reliability and reducing design complexity of the final products. The multi-coil design in the wireless power receiver 110 also provide the required spatial freedom to the user to charge their devices by allowing selective activation of only those receiver coils 125, 130 135, 140 that are in the vicinity of the corresponding wireless transmitter coil.

The wireless power receiver 110 of the present disclosure also provides better misalignment tolerance due to its multi-coil configuration. When the wireless power receiver 110 is misaligned with respect to the wireless power transmitter 105, different receiver coils 125, 130, 135, 140 may have different amount of coupling with the corresponding wireless transmitter coil. In such cases, different receiver coils 125, 130, 135, 140 may receive different amounts of energy from the corresponding wireless transmitter coil. When the wireless power receiver 110 is slightly misaligned with respect to the wireless power transmitter 105, all of the receiver coils 125, 130, 135, 140 are active at the same time and the energy from all of the receiver coils 125, 130. 135, 140 is combined. When the wireless power receiver 110 is substantially misaligned with respect to the wireless power transmitter 105, some of the receiver coils 125, 130, 135, 140 might not be activated to receive energy. In such cases, other receiver coils 125, 130, 135, 140 might be coupled with the corresponding, transmitter coil 115, 120 and receiving energy. This helps to maintain a better power transfer capability compared with the single coil design.

The present disclosure also provides for a cost-effective wireless power receiver 110. By employing multiple smaller receiver coils, as compared to a single large receiver coil, lower voltage and current are induced on each receiver coil, thus low-cost components can now be employed in the wireless power receiver 110. In fact, the employment of the multiple smaller receiver coils also increases the reliability of the wireless power receiver 110. Moreover, due to employment of the multiple smaller receiver coils, the consumption of the ferrite material that is required to cover the receiver coils is also reduced. Instead of one large ferrite material sheet that was used to cover the conventional single large receiver coil, four smaller pieces of ferrite material can now be used to cover the smaller receiver coils. Moreover, this arrangement also reduces the electromagnetic interference in the wireless power transmission systems.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover, in this document, relational terms such as first and second, top and bottom, front and rear, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element preceded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A receiver for wirelessly receiving energy to power a device, the receiver comprising:
a plurality of receiver coils spaced apart from each other, wherein each of the plurality of receiver coils is configured to operate in a same wireless power frequency range and receive the energy from a transmitter; and
a receiver circuitry connected to each of the plurality of receiver coils, the receiver circuitry configured to combine the energy received by each of the plurality of receiver coils to power the device.

2. The receiver of claim 1, wherein each of the plurality of receiver coils is configured to be selectively activated to receive the energy when the respective receiver coil is in the vicinity of the transmitter, and wherein two or more of the plurality of receiver coils are configured to be activated simultaneously to receive the energy when the respective two or more of the plurality of receiver coils are in the vicinity of the transmitter.

3. The receiver of claim 1, wherein each of the plurality of receiver coils is configured to induce an alternating current corresponding to the wireless energy received by the respective receiver coil, and wherein the receiver circuitry comprises:
a plurality of rectifiers correspondingly connected to the plurality of receiver coils, wherein each of the plurality of rectifiers is configured to convert the alternating current received from the corresponding receiver coil into a direct current; and
a control unit connected to the plurality of rectifiers, wherein the control unit is configured to receive and combine the direct current from each of the plurality of rectifiers to power the device.

4. The receiver of claim 3, wherein the receiver circuitry further comprises:
a plurality of matching circuits correspondingly connected between the plurality of receiver coils and the plurality of rectifiers, each of the plurality of matching circuit being configured to match an output impedance of the corresponding receiver coil to an input impedance of the corresponding rectifier.

5. The receiver of claim 1, wherein each of the plurality of receiver coils is configured to induce an alternating current corresponding to the wireless energy received by the respective receiver coil, and wherein the receiver circuitry comprises:
a plurality of matching circuits correspondingly connected to the plurality of receiver coils, each of the plurality of matching circuits being configured to match an output impedance of the corresponding receiver coil to an input impedance of a rectifier; and
the rectifier connected to each of the plurality of matching circuits, the rectifier being configured to combine the alternating current from the plurality of matching circuits for generating a direct current to power the device.

6. The receiver of claim 1, wherein the plurality of receiver coils are connected in series.

7. The receiver of claim 1, wherein the plurality of receiver coils are connected in parallel.

8. A method for wirelessly receiving energy by a receiver to power a device, the method comprising:
receiving, by a plurality of receiver coils, the energy from a transmitter, the plurality of receiver coils being spaced apart from each other and operating in a same wireless power frequency range; and
combining, by a receiver circuitry in the receiver, the energy received by each of the plurality of receiver coils to power the device.

9. The method of claim 8, further comprising:
selectively activating, each of the plurality of receiver coils, to receive the energy when the respective receiver coil is in the vicinity of the transmitter, and wherein two or more of the plurality of receiver coils are activated simultaneously to receive the energy when the respective two or more of the plurality of receiver coils are in the vicinity of the transmitter.

10. The method of claim 8, further comprising:
inducing, by each of the plurality of receiver coils, an alternating current corresponding to the wireless energy received by the respective receiver coil;
converting, by each of a plurality of rectifiers in the receiver circuitry, the alternating current received from the corresponding receiver coil into a direct current; and
receiving and combining, by a control unit in the receiver circuitry, the direct current from each of the plurality of rectifiers to power the device.

11. The method of claim 10, further comprising:
matching, by each of a plurality of matching circuits in the receiver circuitry, an output impedance of the corresponding receiver coil to an input impedance of the corresponding rectifier.

12. The method of claim 8, further comprising:
inducing, by each of the plurality of receiver coils, an alternating current corresponding to the wireless energy received by the respective receiver coil;
matching, by each of a plurality of matching circuits in the receiver circuitry, an output impedance of the corresponding receiver coil to an input impedance of a rectifier; and
combining, by a rectifier in the receiver circuitry, the alternating current from the plurality of matching circuits for generating a direct current to power the device.

13. The method of claim 8, wherein the plurality of receiver coils are connected in series.

14. The method of claim 8, wherein the plurality of receiver coils are connected in parallel.

15. A device comprising:
a receiver configured to wirelessly receive energy for operation of the device, the receiver comprising:
a plurality of receiver coils spaced apart from each other, wherein each of the plurality of receiver coils is configured to operate in a same wireless power frequency range and receive the energy from a transmitter; and
a receiver circuitry connected to each of the plurality of receiver coils, the receiver circuitry configured to combine the energy received by each of the plurality of receiver coils to power the device.

16. The device of claim 15, wherein each of the plurality of receiver coils is configured to be selectively activated to receive the energy when the respective receiver coil is in the vicinity of the transmitter, and wherein two or more of the plurality of receiver coils are configured to be activated simultaneously to receive the energy when the respective two or more of the plurality of receiver coils are in the vicinity of the transmitter.

17. The device of claim 15, wherein each of the plurality of receiver coils is configured to induce an alternating current corresponding to the wireless energy received by the respective receiver coil, and wherein the receiver circuitry comprises:
a plurality of rectifiers correspondingly connected to the plurality of receiver coils, wherein each of the plurality of rectifiers is configured to convert the alternating current received from the corresponding receiver coil into a direct current; and
a control unit connected to the plurality of rectifiers, wherein the control unit is configured to receive and combine the direct current from each of the plurality of rectifiers to power the device.

18. The device of claim 15, wherein each of the plurality of receiver coils is configured to induce an alternating current corresponding to the wireless energy received by the respective receiver coil, and wherein the receiver circuitry comprises:
a plurality of matching circuits correspondingly connected to the plurality of receiver coils, each of the plurality of matching circuits being configured to match an output impedance of the corresponding receiver coil to an input impedance of a rectifier; and
the rectifier connected to each of the plurality of matching circuits, the rectifier being configured to combine the alternating current from the plurality of matching circuits for generating a direct current to power the device.

19. The device of claim 15, wherein the plurality of receiver coils are connected in series.

20. The device of claim 15, wherein the plurality of receiver coils are connected in parallel.
